(19) United States
(12) Patent Application Publication
(10) Pub. No.: US 2002/0088408 A1
(43) Pub. Date: Jul. 11, 2002

(54) Vegetation zone facility

(76) Inventor: Keun-hee Lee, Seoul (KR)

Correspondence Address: Robert E. Bushnell, Suite 300, 1522 K Street, N.W., Washington, DC, 20005-1202, US

(21) Appl. No.: 10/032,499

(22) Filed: Jan. 2, 2002

(30) Foreign Application Priority Data
Jan. 6, 2001 (KR) 2001-732
Apr. 2, 2001 (KR) 2001-18054

(51) Int. Cl. A01K 61/00

(52) U.S. Cl. 119/221

(57) ABSTRACT

The log vegetation zone facility for use of spawning and inhabitation of fish includes a log member which is based on a perpendicularly intersected structure or an accumulation structure of a specific shape so as to form one space in the inside thereof, a weight which is filled in an inside space of the structure body composed of the log members or is installed on a given portion of the log, so as to fix the log structure body in the water and provide a spawning place and inhabitation space of fish, and a vegetation bag which is installed on a given portion of the log member, which is each germinated to form an underwater bush so as to provide a spawning and inhabitation environment of fish. In such construction, a log structure body and a submerged vegetation bush provide an environment in which fish stably spawn and inhabit, naturally purify a contaminated water quality through a composition of the underwater bush in the submerged vegetation, and compose a water-neighboring park matched with a view of a river or a watercourse neighborhood.

### CLAIM OF PRIORITY

This application makes reference to, incorporate the same herein, and claims all benefits accruing 35 U.S.C. § 119 from my application BANK PROTECTION BLOCK AND METHOD OF CONSTRUCTING RIVER SIDE VEGETATION SUPPORT USING THE SAME filed with the Korean Industrial Property Office on Jan. 6, 2001 and there duly assigned Ser. No. 732/2001, and from my application LOG FACILITIES FOR LAYING EGGS AND INHABITATION FOR FISHES IN THE WATER filed with the Korean Industrial Property Office on Apr. 4, 2001 and there duly assigned Serial No. 18054/2001.

### BACKGROUND OF THE INVENTION

1. Field of the Invention

The present invention relates to vegetation zone facilities, and more particularly, to a log vegetation zone facility for use of inhabitation and spawning of fish.

2. Description of the Prior Art

In general, various kinds of fish and underwater organisms live in a lake, a watercourse, and a river under various sorts of underwater inhabitation environments. However, today's industry is getting gradually developed and all sorts of development works are increased. Since the developments destroy natural environment and considerably damage the inhabitation environment, a place for spawning or inhabitation of fish is not given adequately and the resources of fish are gradually reduced. In a case of some fish, it is coming to a crisis for an extermination of a stock.

In a riverside or a shore of a river or watercourse, it is often found a concrete block embankment. The embankment was mostly provided under a consideration of only functional nature in its construction work, in other words, it was not harmonized with a neighboring scene or it was far away from an esthetic sense. Furthermore, it was not adequate to give a place of spawning and inhabitation of fish.

### SUMMARY OF THE INVENTION

It is therefore an object of the present invention to provide an improved vegetation zone facility that is placed in the water.

It is another object to provide an improved vegetation zone facility that provides an inhabitation place for fish.

It is also an object to provide a vegetation zone facility that provides a spawning place for fish.

It is further an object to provide a vegetation zone facility that can be used on an embankment.

It is a still further object to provide a vegetation zone facility that is harmonized with a neighboring scene.

It is yet a further object to provide a vegetation zone facility that is capable of composing an environment-intimate water-neighboring park.

According to the present invention, a vegetation zone facility based on a first embodiment of the invention may be constructed according to the objects of the present invention with a plurality of pillars which is set with a given interval one another, a plurality of horizontal members which is set perpendicular to the pillars, the horizontal members which are connected to the pillars by the connector and installed in such a shape that they function as a storage place, a plurality of weights filled within the storage place for providing an inhabitation and spawning place for fish, and a plurality of vegetation bags which is set on the horizontal members and is filled with vegetation soil mixed with herb seeds.

It is preferred that the shape made by the horizontal members is a triangular shape or a trapezoidal shape of which one side is opened.

According to the present invention, a vegetation zone facility based on a second embodiment of the invention may be constructed according to the objects of the present invention with a plurality of vertical members, a plurality of horizontal members, weights, and vegetation bags. The vertical and horizontal members are distanced by a given interval and are alternately perpendicular-crossed and accumulated so as to form one space in the inside thereof, to thus gain a hexahedron structure body as a whole. The weights are filled in the space and make the structural body immovable in the water. Gaps among the weights provide a spawning place and inhabitation space for fish. The vegetation bags are installed on optional horizontal members.

According to the present invention, a vegetation zone facility based on a third embodiment of the invention may be constructed according to the objects of the present invention with a plurality of horizontal members distanced by a constant interval and disposed in a lattice shape, weights set on both ends of the horizontal members, and vegetation bags installed on the plurality of horizontal members.

It is preferred that the elements of the vegetation zone facility are made of logs.

### BRIEF DESCRIPTIONS OF THE DRAWINGS

A more complete appreciation of the invention, and many of the attendant advantages, thereof, will be readily apparent as the same becomes better understood by reference to the following detailed description when considered in conjunction with the accompanying drawings in which like reference symbols indicate the same or similar components, wherein:

FIG. 1 is a plane view showing the construction of a vegetation zone facility for spawning and inhabitation of fish in a first embodiment which has a triangular shape according to the invention;

FIG. 2 represents a side view for the construction of a vegetation zone facility for spawning and inhabitation of fish according to the invention;

FIG. 3 depicts a plane view showing the construction of a vegetation zone facility for spawning and inhabitation of fish in a first embodiment which has a trapezoidal shape according to the invention;

FIG. 4 illustrates a side view for the construction of a vegetation zone facility for spawning and inhabitation of fish according to the invention;

FIG. 5 is a plane view providing the construction of a vegetation zone facility for spawning and inhabitation of fish in a second embodiment according to the invention;

FIG. 6 provides a perspective view for the construction of a vegetation zone facility for spawning and inhabitation of fish in a second embodiment according to the invention;

FIG. 7 furnishes a plane view showing the construction of a vegetation zone facility for spawning and inhabitation of fish in a third embodiment according to the invention; and

FIG. 8 is a perspective view for the construction of a vegetation zone facility for spawning and inhabitation of fish in a third embodiment according to the invention.

### DETAILED DESCRIPTION OF THE PREFERRED EMBODIMENTS

A preferred embodiment of the present invention will be described in more detail with reference to the accompanying drawings.

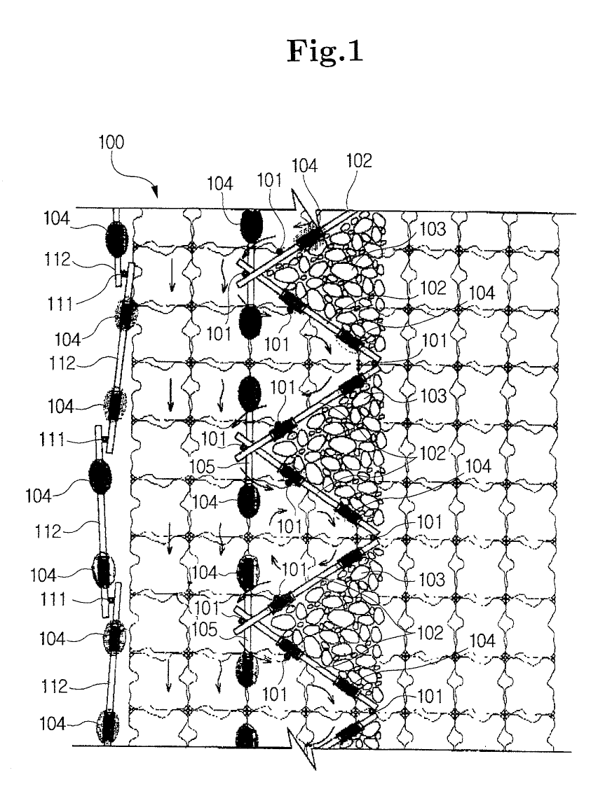

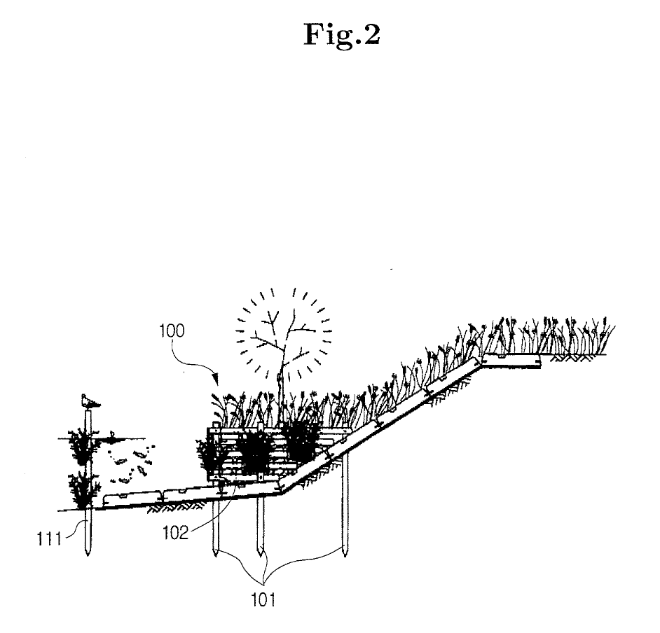

With reference to FIGS. 1 and 2, a vegetation zone facility 100 for use of spawning and inhabitation of fish in a first embodiment of the invention is arranged on a boundary area between a riverside slant and its lowering consecutive flat part, and includes a plurality of vertical pillar members 101, a plurality of horizontal members 102, weights 103, and a vegetation bag 104 having the soil or the artificial soil which contains seeds of a submerged herbaceous plant such as a water lily, a nuphar japonicum, a hydrilla verticillata, and a water-caltrop.

The plurality of vertical pillar members 101 are positioned on the slant of the riverside and its flat part with a mutually given interval. It is preferred to use logs as these vertical pillar members 101, considering a germination of submerged vegetation through the vegetation bag 104 and its fine view.

The plurality of horizontal members 102 are installed with a constant interval in a multilayer accumulated structure through a connector of the vertical pillar members 101 . This structure provides a storage place of cobblestone and rubble 103. It is preferred that this structure has a series of triangular shapes of which one side is opened on a plane drawing. Like the vertical members 101, it is also desirable to use a log for the plurality of horizontal members 102.

The weights, preferably cobblestone and rubble 103, are filled inside a structure body constructed by the vertical members 101 and the horizontal members 102, and provide an inhabitation place for underwater organisms.

It is preferred that, on a bottom and a side faces of the structure body constructed by the vertical members 101 and horizontal member 102, a protective film, which is preferably made of natural fiber, is set to prevent a loss of the soil. It is also preferred that the cobblestone and rubble 103 is filled on the protective film.

A plurality of vegetation bags 104 is set on the horizontal member 102. The vegetation bags contain natural or artificial soil mixed with submerged herb seeds. This vegetation bag 104 is preferably made of jute fiber material.

It is preferred that, at a vertex where the plurality of horizontal members 102 meet with one another, supplemental horizontal members 105 which are preferably made of logs are further installed in a length direction of a river or a watercourse. Such supplemental horizontal member 105 makes a flow of water eddy, together with the plurality of horizontal members 102, to thus compose a cozy underwater space for fish. The supplemental horizontal member 105 can have the vegetation bag 104 on its ends.

Additionally, an auxiliary vegetation zone can be made along with a direction of the watercourses, at a position distanced from the main vegetation zone to a central part of the river or watercourses. The auxiliary vegetation zone includes a plurality of auxiliary vertical pillar members 111 and a plurality of auxiliary horizontal members 112. The auxiliary horizontal members connect the vertical members 111 with one another. On both ends of the auxiliary horizontal members 112 are further installed the vegetation bags 104. This auxiliary vegetation zone makes an inhabitation environment of the underwater organism much better.

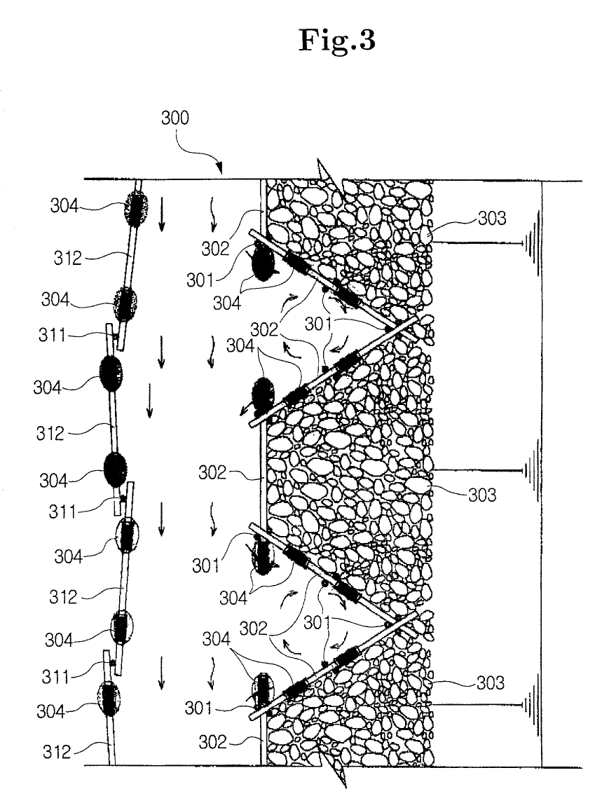

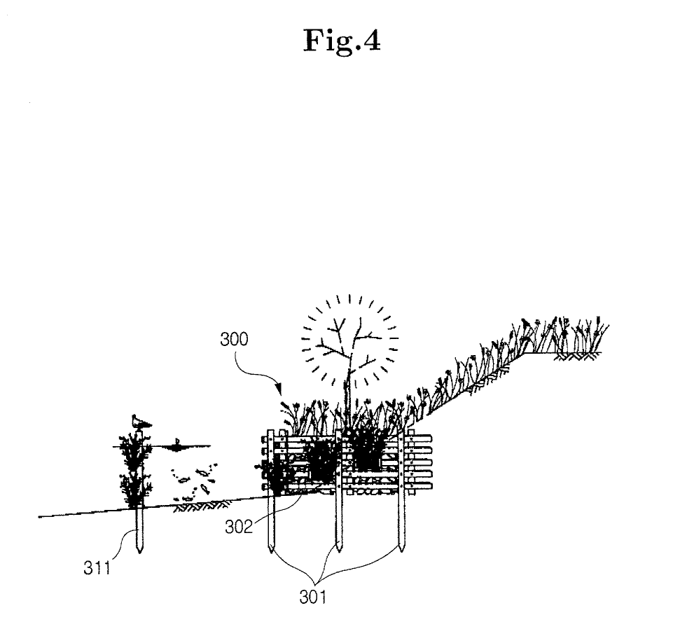

Referring to FIGS. 3 and 4, a vegetation zone facility 300 for use of spawning and inhabitation of fish is same as the vegetation zone facility 100 of FIG. 1 and 2 in the basic structure. Therefore, a description for the same structural elements is omitted herein and only different characteristic elements will be described in the following.

In comparison with the vegetation zone facility 100 of FIG. 1, the vegetation zone facility 300 of FIGS. 3 and 4 has such a different characteristic from the vegetation zone facility of FIG. 1 that the structure made by the horizontal members 302 has a trapezoidal shape that one side thereof is opened on a plane drawing. After installing the vegetation zone facilities 300, the vegetation grows and is exposed on a water level so that the exposed vegetation composes a water-neighboring park. Thus, there is a difference in an esthetic aspect between the vegetation facility of FIG. 1 which has the underwater bush area of a triangular shape of which one side is opened and the vegetation facility of FIGS. 3 which has the underwater bush area of a trapezoidal shape of which one side is opened. In FIGS. 3 and 4, a reference number 303 indicates cobblestone and rubble, 304 a vegetation bag, 311 an auxiliary vertical pillar member, and 312 an auxiliary horizontal member.

It is also preferred to use logs as an auxiliary vertical pillar member and an auxiliary horizontal member.

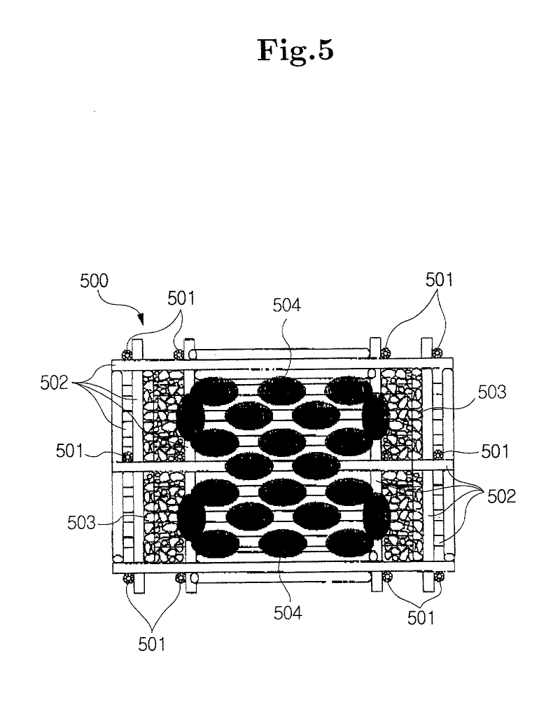

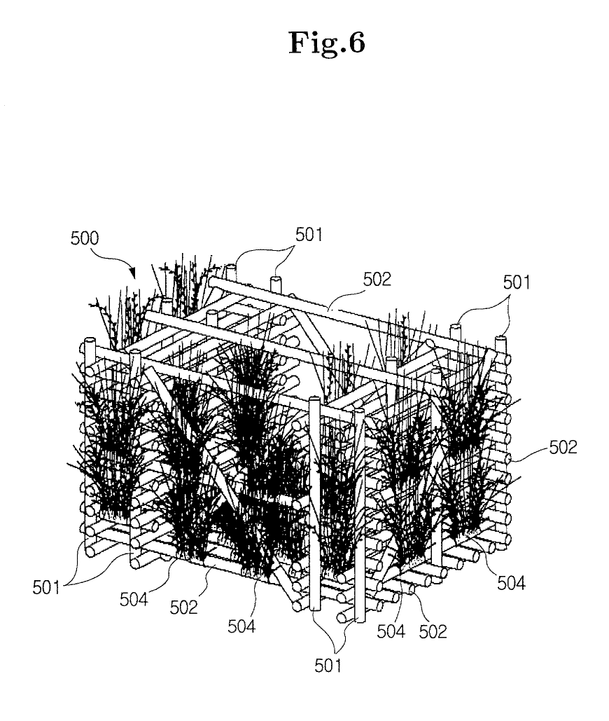

With reference to FIGS. 5 and 6, a vegetation zone facility 500 for use of spawning and inhabitation of fish in a second embodiment of the present invention is constructed with a plurality of vertical and horizontal members 501, 502, cobblestone and rubble 503 and a vegetation bag 504.

The plurality of vertical and horizontal members 501, 502 are distanced by a mutually given interval, and are alternately perpendicularly intersected with each other and accumulated so as to get a hexahedron structure body as a whole. In particular, in two side faces confronted with each other, i.e., the left and right side faces in FIG. 5, among six faces of this hexahedron structure body, the vertical and the horizontal members 501, 502 are densely accumulated and reiterated relatively to other parts, to gain a dual wall body structure. Such dense structure provides more cozy space for spawning and inhabitation of fish and also provides a stabilized shelter for fish against a danger from the outside. The other two side faces which are opposite to each other, i.e., the front and rear faces in FIG. 5, are further provided with a net for more stabilized inhabitation space for a fry.

The cobblestone and rubble 503 are filled within the space of the structure body constructed by the plurality of vertical and horizontal members 501, 502 so that the vegetation zone facility 500 is fixed by its load weight in the water. The cobblestone and rubble 503 is preferably filled within the dual wall body structure, if any. Gaps formed among the weights serve as a spawning place and inhabitation space of fish.

The vegetation bag 504 is installed on an optional horizontal member among the plurality of horizontal members 501, 502, and is each germinated to form an underwater bush and provide a spawning and inhabitation environment for fish.

The vegetation zone facility 500 for use of fish spawning and inhabitation based on the third embodiment of the invention is mainly set and used in a position where a change of a water level is small, such as a flash-water lake of about 2 to 3 meter in the depth of water, or a river or watercourses.

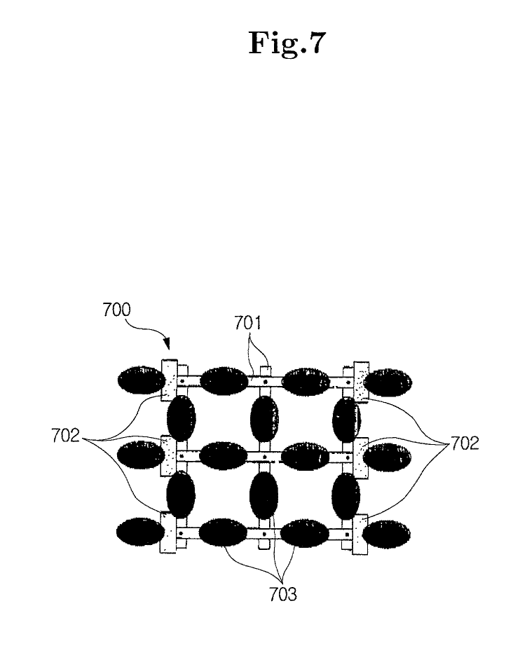

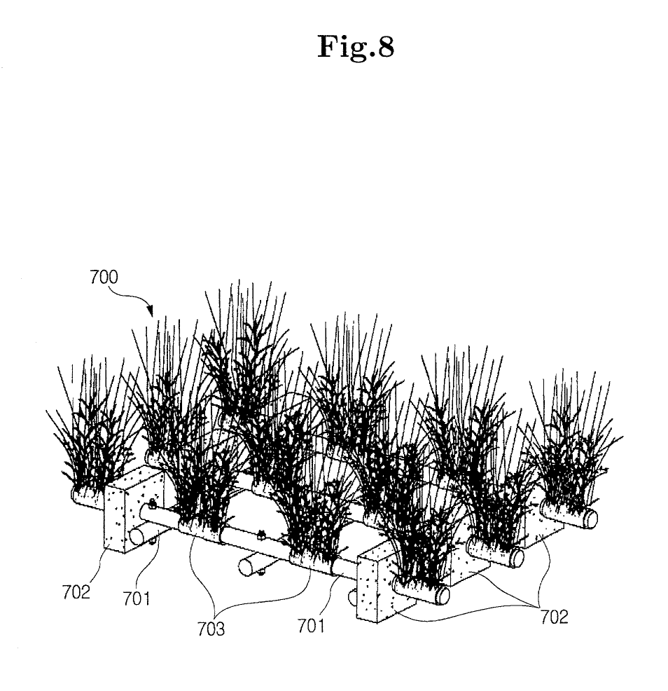

FIGS. 7 and 8 depict a plane view and a perspective view showing the construction of a vegetation zone facility for spawning and inhabitation of fish in a third embodiment of the invention.

Referring to FIGS. 7 and 8, the vegetation zone facility 700 for spawning and inhabitation of fish is largely constructed by a plurality of horizontal members 701, weights 702 and vegetation bags 703.

The plurality of horizontal members 701 are distanced by a mutually constant interval, and are perpendicularly intersected with one another and disposed to get a structure body of a lattice shape as a check shape. The horizontal members 701 are mutually combined and fixed by a fastener such as a bolt. A combining method of the horizontal members 701, however, is not definitely restricted as such a fastener, but they can be combined and fixed by a binder such as a string or a line.

The weights 702 are set on both ends of the horizontal members 701, and serves as a role of fixing the log structure body of the lattice shape in the water by using the load weight thereof. It is preferred to use as a concrete block 702 of a hexahedral shape having a through hole into which the horizontal member 701 is inserted. Natural stone can be also processed and used. Its shape may be nontypical shape instead of the hexahedron. That is, it is valid to utilize even any shape which has a formation of a through-hole into which the horizontal member 701 is inserted.

The vegetation bag 703 is installed on a constant portion of the plurality of horizontal members 701, and is each germinated to form a bush and compose a spawning and inhabitation environment of fish. Though the drawing herein shows such a vegetation bag 703 which is set, being surrounded around the horizontal member 701, it is just to represent one example out of installation methods. Thus it can be used a method that the vegetation bag 703 is constructed as one roll type and is fixed onto one side face of the horizontal member 701 by using a binder such as a string or a line. Further, though the submerged herbal sort seed can be put together with soil inside the vegetation bag 703 like the aforedescribed embodiments, according to some cases the submerged herbal sort seedling can be directly planted in the vegetation bag 703.

The vegetation zone facility 700 described in FIGS. 7 and 8 is mainly installed and used in the water of about 1 m in the depth of water.

It is preferred that the elements of the vegetation zone facilities as described above are made of logs.

As aforementioned, in accordance with the present invention, a vegetation zone facility provides a structure body and a submerged vegetation bush which are good for spawning and inhabitation offish. Furthermore, there is not only an additional effect of naturally purifying a contaminated water quality through a composition of an underwater bush in vegetation, but also a merit of composing a water-neighboring park matched with a view of a river or a watercourse neighborhood.

Although the preferred embodiments of the present invention have been disclosed for an illustrative purpose, those skilled in the art will appreciate that various modifications, additions and substitutions are possible, without departing from the scope and spirit of the invention as disclosed in the accompanying claims.

What is claimed is:

1. A vegetation zone facility, comprising:
a plurality of first pillars set at a given distance from one another, the first pillars having connectors;
a plurality of first horizontal members set perpendicular to the first pillars, the first horizontal members connected to the first pillars by said connectors, said first horizontal members installed in such a shape as to provide a storage place;
a plurality of weights filled within said storage place, gaps among said plurality of weights providing a spawning place and inhabitation space of fish; and
a plurality of first vegetation bags set on said first horizontal members, said first vegetation bags having soil mixed with a herb seed.

2. The vegetation zone facility of claim 1, further comprised of said plurality of first horizontal members and said plurality of first pillars made of logs.

3. The vegetation zone facility of claim 1, further comprised of said weights comprising cobblestone and rubble.

4. The vegetation zone facility of claim 1, further comprised of a protective film surrounding said plurality of first pillars and said plurality of first horizontal members to prevent a loss of the soil and the weight.

5. The vegetation zone facility of claim 1, further comprised of the first vegetation bags made of jute.

6. The vegetation zone facility of claim 1, wherein said shape is a series of triangular shapes and one side of each of the triangular shapes is opened on a plain view.

7. The vegetation zone facility of claim 6, further comprised of:
the first horizontal members made of logs;
the first pillars made of logs; and
the weights comprising cobblestone and rubble.

8. The vegetation zone facility of claim 6, further comprised of a protective film surrounding said plurality of first pillars and said plurality of first horizontal members to prevent a loss of the soil and the weights.

9. The vegetation zone facility of claim 6, further comprising an auxiliary vegetation zone set along a length direction of a watercourse at a position distanced by a constant distance from a vertex of said triangular shape to a central part of the watercourse, said auxiliary vegetation zone having second pillars and second horizontal members, said second pillars connected with one another by said second horizontal members, each of said second horizontal members having a second vegetation bag having soil mixed with a herb seed.

10. The vegetation zone facility of claim 6, further comprising a plurality of third horizontal members installed in a length direction of a watercourse and at vertex portions of said triangular shapes, said plurality of third horizontal members having third vegetation bags on their ends.

11. The vegetation zone facility of claim 1, wherein said shape is a series of trapezoidal shapes on a plane view, each of said trapezoid shapes has a longer parallel side and a shorter parallel side, and said longer parallel side of each of said trapezoid shapes is opened.

12. The vegetation zone facility of claim 11, further comprised of:
the first horizontal members made of logs;
the first pillars made of logs; and
the weight comprising cobblestone and rubble.

13. The vegetation zone facility of claim 11, further comprised of a protective film surrounding said first pillars and said first horizontal members to prevent a loss of the soil and the weights.

14. The vegetation zone facility of claim 11, further comprising an auxiliary vegetation zone set along a length direction of a watercourse at a position distanced by a constant distance from the shorter parallel sides of said trapezoidal shape to a central part of the watercourse, said auxiliary vegetation zone having second pillars and second horizontal members, said second pillars connected with one another by said second horizontal members, each of said second horizontal members having a second vegetation bag having soil mixed with a herb seed.

15. A vegetation zone facility, comprising:
a plurality of first vertical members;
a plurality of first horizontal members, said plurality of first vertical and horizontal members distanced by a given interval and alternately perpendicular-crossed and accumulated so as to form one space in an inside thereof, to thus gain a hexahedron structure body as a whole;
a plurality of weights filled in said space, said plurality of weights making said structural body immovable in the water, gaps among said plurality of weights providing a spawning place and inhabitation space for fish; and
a plurality of vegetation bags installed on optional horizontal members among said plurality of horizontal members, said plurality of vegetation bags having soil mixed with herb seeds.

16. The vegetation zone facility of claim 15, wherein the first horizontal and the first vertical members are made of logs.

17. The vegetation zone facility of claim 15, further comprised of the weights comprising cobblestone and rubble.

18. The vegetation zone facility of claim 15, wherein a first and a second sidewalls of said hexahedron structure body, opposing each other, are densely accumulated and reiterated, relatively to the other sidewalls of said hexahedron structural body, to gain a dual wall structure.

19. The vegetation zone facility of claim 18, further comprising a first net covering a third sidewall and a second net covering a fourth sidewall of said hexahedron structure body, said third and said fourth sidewalls opposing each other and having a single wall structure.

20. The vegetation zone facility, comprising:
a plurality of first horizontal members distanced by a constant interval;
a plurality of second horizontal members distanced by a constant interval and disposed perpendicular to said plurality of first horizontal members;
a plurality of weights set on both ends of said plurality of first horizontal members; and
a plurality of vegetation bags installed on the plurality of first and second horizontal members, said plurality of vegetation bags having a herb seed.

21. The vegetation zone facility of claim 20, further comprising a fastener fastening the first horizontal member with the second horizontal member.

22. The vegetation zone facility of claim 20, wherein said vegetation bag surrounds said horizontal members.

23. The vegetation zone facility of claim 20, further comprised of the first and the second horizontal members are made of logs.

24. The vegetation zone facility of claim 20, further comprised of the weights comprising a concrete block of a hexahedron shape, said concrete block having a hole through which the first horizontal member is inserted.
